(19) United States
(12) Patent Application Publication
(10) Pub. No.: US 2012/0007891 A1
(43) Pub. Date: Jan. 12, 2012

(54) HUMAN MACHINE INTERFACE PRESENTING METHOD, HANDHELD DEVICE USING THE SAME, AND COMPUTER READABLE MEDIUM THEREOF

(75) Inventor: Chi-Pang Chiang, Taoyuan County (TW)

(73) Assignee: HTC CORPORATION, Taoyuan County (TW)

(21) Appl. No.: 13/176,765

(22) Filed: Jul. 6, 2011

Related U.S. Application Data
(60) Provisional application No. 61/361,532, filed on Jul. 6, 2010.

(51) Int. Cl. G09G 5/00

(52) U.S. Cl. 345/650

(57) ABSTRACT

A human-machine interface presenting method, a handheld device using the same, and a computer readable medium thereof are provided. The human-machine interface presenting method is adapted to the handheld device and includes following steps. A first content generated according to a first attribute set is displayed. When a change in the orientation of the handheld device is detected, a second attribute set is generated according to the change, and a second content different from the first content is displayed according to the second attribute set, where the first attribute set and the second attribute set contain at least an identical attribute.

### CROSS-REFERENCE TO RELATED APPLICATION

This application claims the priority benefits of U.S. provisional application Ser. No. 61/361,532, filed on Jul. 6, 2010. The entirety of the above-mentioned patent application is hereby incorporated by reference herein and made a part of this specification.

### BACKGROUND

1. Field of the Invention

The invention generally relates to a human machine interface presenting method, and more particularly, to a method for presenting a human machine interface according to the orientation of a handheld device, the handheld device using the same method, and a computer readable medium thereof.

2. Description of Related Art

Presently, a G-sensor is usually equipped within a handheld device (for example, a smart phone or a tablet PC) to detect the current orientation of user operations and adjust the screen display according to the current orientation. However, in most cases, when a handheld device is changed from a portrait layout into a landscape layout, the same information or a similar image is simply presented to the user, and the user does not get diversified information from the change of the orientation. In order to get the desired information, the user may have to perform several switch operations or select corresponding items in the menu, which are not inconvenient. Therefore, operation experience of the user does not change with the orientation of the handheld device.

### SUMMARY

Accordingly, the invention is directed to a a human machine interface presenting method, a handheld device using the same method, and a computer readable medium thereof, where when the handheld device is detected to change from a portrait layout to a landscape layout, an originally displayed local view human machine interface is switched to an overview human machine interface so that a plurality of information items with different attributes is presented to a user.

According to an embodiment of the invention, a human machine interface presenting method is provided. The human machine interface presenting method is adapted to a handheld device and includes following steps: (a) displaying a first content generated according to a first attribute set; (b) detecting a change in the orientation of the handheld device; (c) generating a second attribute set according to the change; and (d) displaying a second content different from the first content according to the second attribute set, where the first attribute set and the second attribute set contain at least an identical attribute.

According to an embodiment of the invention, the first content is a first human machine interface, the second content is a second human machine interface, the change is that the handheld device changes from a portrait layout to a landscape layout, and in the foregoing step (d), the display unit is controlled to change from displaying the first human machine interface to displaying the second human machine interface according to the second attribute set.

According to an embodiment of the invention, the foregoing step (d) includes: changing from the first human machine interface in which a weather information image of a single location is displayed to the second human machine interface in which a simplified weather information image of multiple locations is displayed in a 3D earth image according to a location attribute.

According to an embodiment of the invention, the foregoing step (d) includes: changing from the first human machine interface in which a weather information image of a single location is displayed to the second human machine interface in which a simplified weather information image of multiple locations is displayed in a 2D world map image according to a location attribute.

According to an embodiment of the invention, the foregoing step (d) includes: changing from the first human machine interface in which a plurality of pictures is displayed in a stacked manner to the second human machine interface in which the pictures respectively corresponding to multiple locations are transversely arranged in a 2D map according to a location attribute.

According to an embodiment of the invention, the foregoing step (d) includes: changing from the first human machine interface in which a plurality of pictures is displayed in a stacked manner to the second human machine interface in which the pictures respectively corresponding to multiple locations and a date are displayed in a 2D map according to a location attribute and a date attribute; displaying a plurality of date items in the second human machine interface according to the date attribute; and when one of the date items is selected, displaying the pictures respectively corresponding to multiple locations on the selected date in the 2D map.

According to an embodiment of the invention, the foregoing step (d) includes: changing from the first human machine interface in which a calendar image of a plurality of time information is displayed to the second human machine interface in which the time information respectively corresponding to multiple locations is displayed in a 2D map according to a location attribute and a time attribute.

According to an embodiment of the invention, when the handheld device is in the landscape layout, the first human machine interface does not display the locations respectively corresponding to the time information.

According to an embodiment of the invention, the foregoing step (d) includes: changing from the first human machine interface in which a calendar image of a plurality of time information is displayed to the second human machine interface in which the time information respectively corresponding to multiple locations and a date is displayed in a 2D map according to a location attribute and a date attribute; displaying a plurality of date items in the second human machine interface according to the date attribute; and when one of the date items is selected, displaying the time information respectively corresponding to multiple locations and the selected date in the 2D map.

According to an embodiment of the invention, a handheld device including a display unit, a detecting unit, and a control unit is provided. The display unit displays a first content, wherein the first content is generated according to a first attribute set. The detecting unit detects a change in the orientation of the handheld device. The control unit is connected to the display unit and the detecting unit. The control unit generates a second attribute set according to the change and controls the display unit to display a second content different from the first content according to the second attribute set, where the first attribute set and the second attribute set contain at least an identical attribute.

According to an embodiment of the invention, a computer readable medium storing a computer executable program is provided. When the computer executable program is loaded into a handheld device, the computer executable program allows the handheld device to execute following steps. A first content generated according to a first attribute set is displayed. When a change in the orientation of the handheld device is detected, a second attribute set is generated according to the change, and a second content different from the first content is displayed according to the second attribute set, where the first attribute set and the second attribute set contain at least an identical attribute.

According to the aforementioned descriptions, embodiments of the invention provide a human machine interface presenting method, a handheld device using the same method, and a computer readable medium thereof. When the handheld device is detected to change from a portrait layout to a landscape layout, an originally displayed first human machine interface is switched to a second human machine interface, so as to present a plurality of information items with different attributes to a user. Thereby, the human machine interfaces can be operated conveniently, and user operation experience can be improved.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a function block diagram of a handheld device according to an embodiment of the invention.

FIG. 2 is a flowchart of a method for a human machine interface presenting method according to a first embodiment of the invention.

FIG. 3A is a schematic diagram of a first human machine interface.

FIG. 3B is a schematic diagram of a second human machine interface according to the first embodiment of the invention.

FIG. 3C is a schematic diagram of a second human machine interface according to a second embodiment of the invention.

FIG. 3D is a flowchart of a human machine interface presenting method according to the first embodiment of the invention.

FIG. 3E is a flowchart of a human machine interface presenting method according to the second embodiment of the invention.

FIG. 4A is a schematic diagram of another first human machine interface.

FIG. 4B is a schematic diagram of a second human machine interface according to a third embodiment of the invention.

FIG. 4C is a schematic diagram of a second human machine interface according to a fourth embodiment of the invention.

FIG. 4D is a flowchart of a human machine interface presenting method according to the third embodiment of the invention.

FIG. 4E is a flowchart of a human machine interface presenting method according to a fourth embodiment of the invention.

FIG. 5A is a schematic diagram of another first human machine interface.

FIG. 5B is a schematic diagram of a second human machine interface according to a fifth embodiment of the invention.

FIG. 5C is a flowchart of a human machine interface presenting method according to the fifth embodiment of the invention.

FIG. 5D is a flowchart of a human machine interface presenting method according to a sixth embodiment of the invention.

### DESCRIPTION OF THE EMBODIMENTS

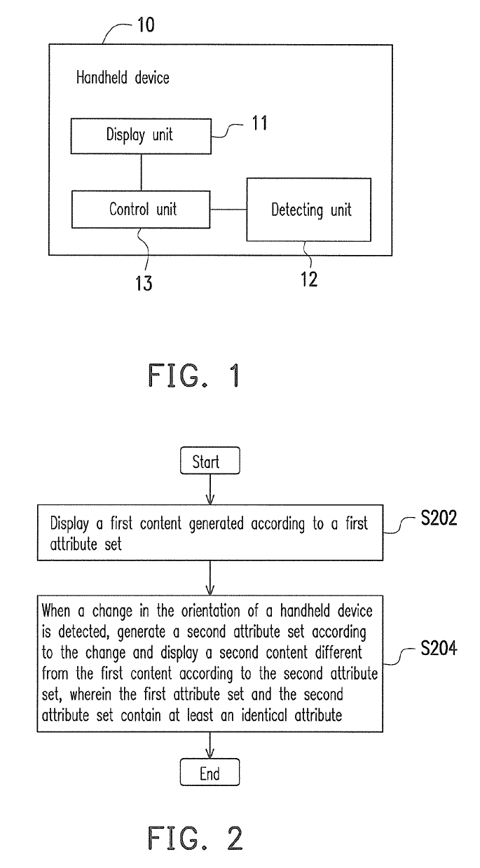

FIG. 1 is a function block diagram of a handheld device 10 according to an embodiment of the invention. When the orientation of the handheld device 10 changes, the handheld device 10 switches between a local view human machine interface and an overview human machine interface. The overview human machine interface can also be referred to as a global view human machine interface, which provides information different from that provided by the local view human machine interface or presents diversified information to a user, so that the human machine interfaces can be operated conveniently and the operation experience of the user can be improved.

For example, the orientation can be changed from a portrait layout to a landscape layout or from the landscape layout to the portrait layout. However, the invention is not limited thereto.

The handheld device 10 includes a display unit 11, a detecting unit 12, and a control unit 13. The control unit 13 is connected to the display unit 11 and the detecting unit 12. The display unit 11, which can be a display or a touch screen, is configured for displaying a first content, where the first content is generated according to a first attribute set. In addition, the detecting unit 12, which can be a G-sensor, is configured for detecting a change in the orientation of the handheld device 10 (especially when the orientation changes from a portrait layout to a landscape layout).

Moreover, when the detecting unit 12 detects a change in the orientation of the handheld device 10, the control unit 13 can control the display unit 11 to switch between a first human machine interface and a second human machine interface. The control unit 13 can include a processor unit, an operating system, and related display firmwares (software programs) for driving or controlling the display unit 11 to present an image of a human machine interface. To be illustrated more clearly, the control unit 13 generates a second attribute set according to the change in the orientation of the handheld device 10 and controls the display unit 11 to display a second content different from the first content according to the second attribute set, where the second attribute set and the first attribute set contain at least an identical attribute.

It is noted that in the invention, an attribute can be a location attribute, a date attribute, a stock market attribute, or a time attribute. However, the invention is not limited thereto. The first attribute set and the second attribute set respectively contain at least an attribute, and at least one of the attributes in the first attribute set has to be the same as at least one of the attributes in the second attribute set. For example, the first attribute set contains a location attribute, and the second attribute set contains a location attribute and a date attribute, where the location attribute is the same attribute in the first attribute set and the second attribute set. The functionality of the attributes will be further described below.

The first content is a first human machine interface, and the second content is a second human machine interface. To be illustrated more clearly, the first human machine interface is a “local view human machine interface”, and the second human machine interface is an “overview human machine interface”. The change can be that the handheld device 10 changes from a portrait layout to a landscape layout. The control unit 13 controls the display unit 11 to change from displaying the first human machine interface to displaying the second human machine interface according to the second attribute set.

Operation and technical characteristics of the control unit 13 will be described below in detail in accordance with FIG. 2. FIG. 2 is a flowchart of a human machine interface presenting method according to a first embodiment of the invention. The human machine interface presenting method starts from step S202. In the step S202, the control unit 13 controls the display unit 11 to display a first content generated according to a first attribute set.

In step S204, when the detecting unit 12 detects a change in the orientation of the handheld device 10, the control unit 13 generates a second attribute set according to the change and controls the display unit 11 to display a second content different from the first content according to the second attribute set, where the first attribute set and the second attribute set contain at least an identical attribute. In other words, when the detecting unit 12 detects that the handheld device 10 changes from a portrait layout to a landscape layout, the control unit 13 controls the display unit to change from displaying the first human machine interface to displaying the second human machine interface according to the second attribute set.

On the other hand, when the handheld device 10 is in the portrait layout and presents the first human machine interface, it does not display the information items presented in the second human machine interface, and the handheld device 10 displays just part of the information items in the portrait layout, or displays the information items in a stacked manner in the portrait layout.

Technical contents of the foregoing steps S202 and S204 will be described in more detail in accordance with six following exemplary embodiments and accompanying drawings.

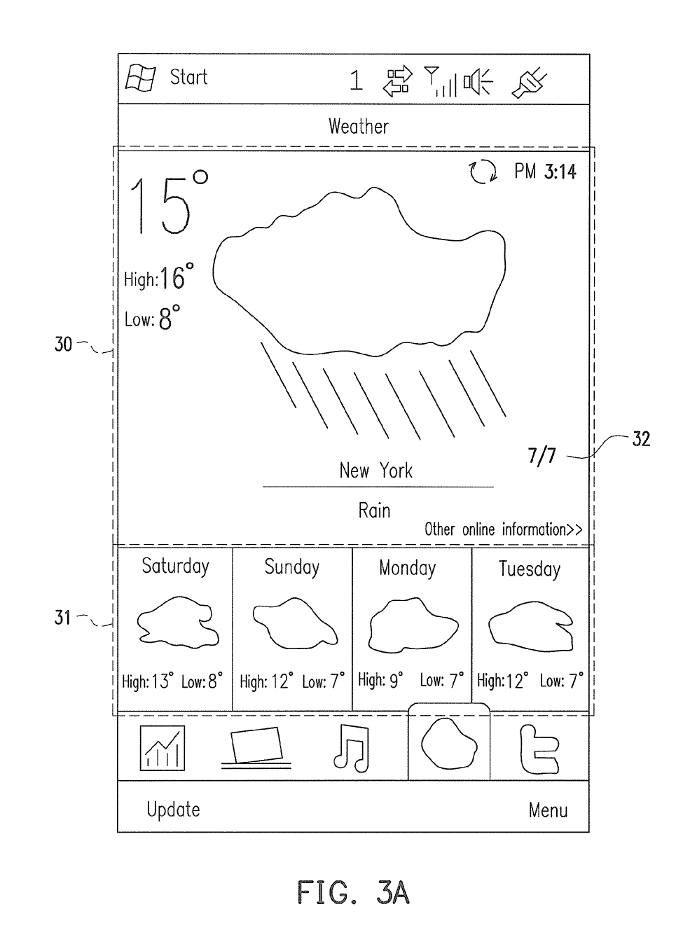

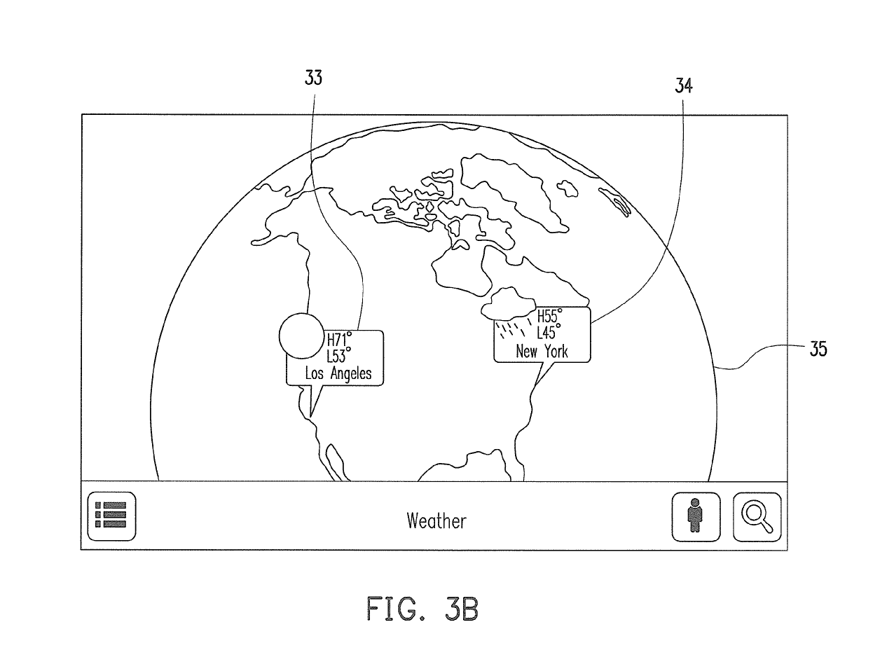

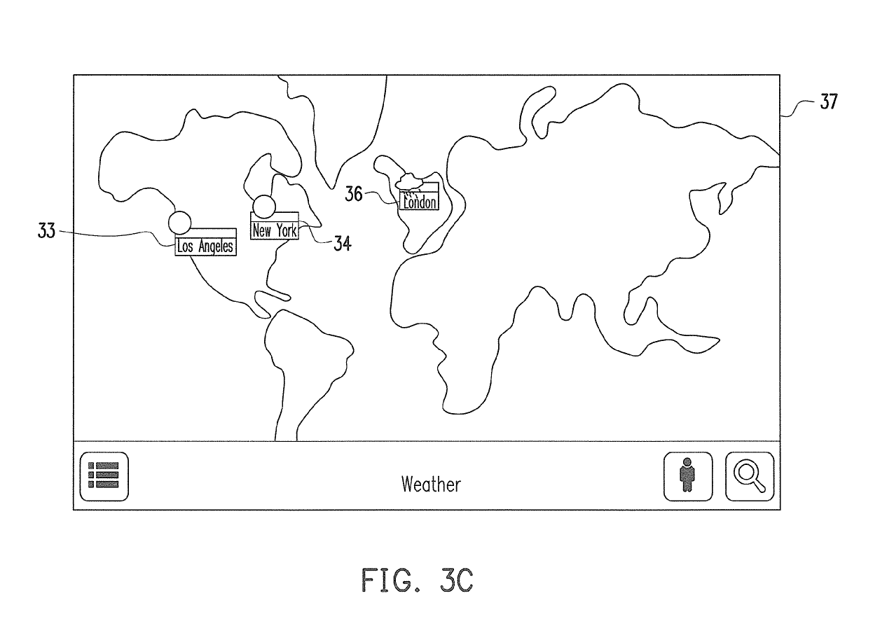

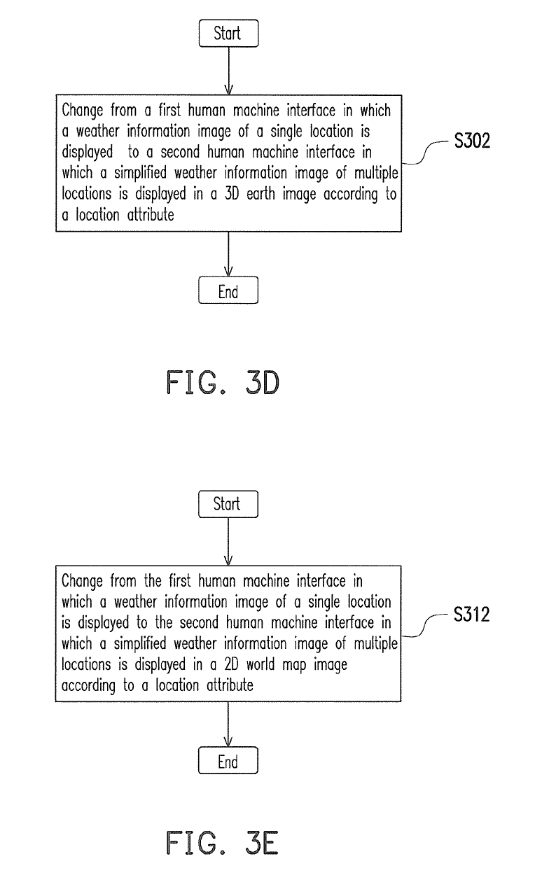

FIG. 3A is a schematic diagram of a first human machine interface. Referring to FIG. 3A, the first human machine interface includes a current day information image 30 and a future information image 31 of a weather information image. The weather information of the current day of a location and a location number 32 are displayed in the current day information image 30, where the location number 32 indicates the total number of other locations to which the user can switch (for example, through a gesture or selecting a menu function).

The weather forecast information in the next several days (or the next week) of a same location is displayed in the future information image 31. However, when the user wants to acquire the weather information of other locations, the conventional techniques do not provide a method for instantly presenting the information, and thus the user can just acquire the weather information of other location through several switching gestures or menu function selections, which can be very inconvenient.

FIG. 3B is a schematic diagram of a second human machine interface according to the first embodiment of the invention. In the present embodiment, when the user changes the orientation of the handheld device 10 from a portrait layout to a landscape layout, in the step S204, the control unit 13 of the handheld device 10 generates a second attribute set according to the change and controls the display unit 11 to display a second content different from the first content according to the second attribute set. Namely, the control unit 13 controls the display unit 11 to switch from the first human machine interface presented by the handheld device 10 in the portrait layout to the second human machine interface according to the second attribute set. In the first embodiment, the first attribute set contains just one location and the weather information thereof, while the second attribute set contains the weather information of different locations.

The second human machine interface is as shown in FIG. 3B. Referring to FIG. 3B, a 3D earth image 35 is displayed in the second human machine interface, and the 3D earth image 35 displays the weather information (for example, the first location 33 and the second location 34 shown in FIG. 3B) of two or more locations. The user can switch to other locations in the 3D earth image 35 through gestures (for example, the user can rotate the 3D earth image 35 to switch to other locations, and the weather information of two or more other locations is still displayed after the switching). Thus, the human machine interface presenting method provided by the invention can provide general weather information of two or more locations at the same time and greatly reduce the number of switching operations performed by a user.

FIG. 3D is a flowchart of a human machine interface presenting method according to the first embodiment of the invention. The procedure illustrated in FIG. 3D is corresponding to the diagram illustrated in FIG. 3B, and illustrates the detailed technical features of the step S204 more clearly. Referring to FIG. 1 and FIGS. 3A-3D, in step S302, the control unit 13 controls the display unit 11 to change from the first human machine interface in which a weather information image of a single location is displayed (as the image in FIG. 3A) to the second human machine interface in which a simplified weather information image of multiple locations is displayed in a 3D earth image 35 (as the image in FIG. 3B) according to a location attribute.

Referring to FIG. 3A and FIG. 3B from another perspective, the user reads the weather information of the same location at different time in the first human machine interface illustrated in FIG. 3A and reads the weather information of different locations at the same time in the second human machine interface illustrated in FIG. 3B. Namely, in FIG. 3B, the weather information of different locations is presented according to a time attribute. Through the human machine interface presenting method provided by the present embodiment, the operation of the human machine interfaces is made very convenient and the operation experience of the user is improved.

FIG. 3C is a schematic diagram of a second human machine interface according to a second embodiment of the invention. The present embodiment provides a second human machine interface different from that illustrated in FIG. 3B. In the present embodiment, when the user changes the orientation of the handheld device 10 from a portrait layout to a landscape layout, the control unit 13 of the handheld device 10 generates a second attribute set according to the change and controls the display unit 11 to display a second content different from the first content according to the second attribute set. Namely, the first human machine interface presented by the handheld device 10 in the portrait layout is switched to another second human machine interface. In the second embodiment, the first attribute set contains only one location and the weather information thereof, while the second attribute set contains the weather information of different locations.

The second human machine interface is as shown in FIG. 3C. Referring to FIG. 3C, a 2D world map image 37 is displayed in the second human machine interface, and the 2D world map image 37 displays the weather information of two or more locations (for example, the first location 33, the second location 34, and the third location 36 in FIG. 3C).

The invention is not limited to the content described above, and the 2D world map image 37 in the second human machine interface can display general weather information of all locations (and can display more than three locations). In the 2D world map image 37, the user can acquire the weather information of all the locations without any gesture. Thus, the human machine interface presenting method provided by the invention can greatly reduce the number of switching operations performed by a user.

FIG. 3E is a flowchart of a human machine interface presenting method according to the second embodiment of the invention. The procedure illustrated in FIG. 3E is corresponding to the diagram illustrated in FIG. 3C, and FIG. 3C illustrates the detailed technical features of the step S204 more clearly. Referring to FIG. 1, FIG. 3A, FIG. 3C, and FIG. 3D, in step S312, the control unit 13 controls the display unit 11 to change from the first human machine interface in which a weather information image of a single location is displayed (as the image in FIG. 3A) to the second human machine interface in which a simplified weather information image of multiple locations is displayed in a 2D world map image (as the image in FIG. 3C) according to a location attribute.

The procedures illustrated in FIG. 3D and FIG. 3E can also be applied to other fields (for example, an image for presenting stock market information). Different information can be displayed in the first human machine interface and the second human machine interface by using two different attributes (for example, a location attribute and a stock market attribute). For example, the stock price information of different companies at the same location (i.e., the same stock market) is displayed in the first human machine interface, and after the handheld device 10 changes from the portrait layout to the landscape layout, the second human machine interface is displayed to present stock index information of different stock markets at different locations. Thereby, the user can conveniently acquire different information presentations by changing the orientation of the handheld device 10 without performing any menu selection or switching operation by gesture.

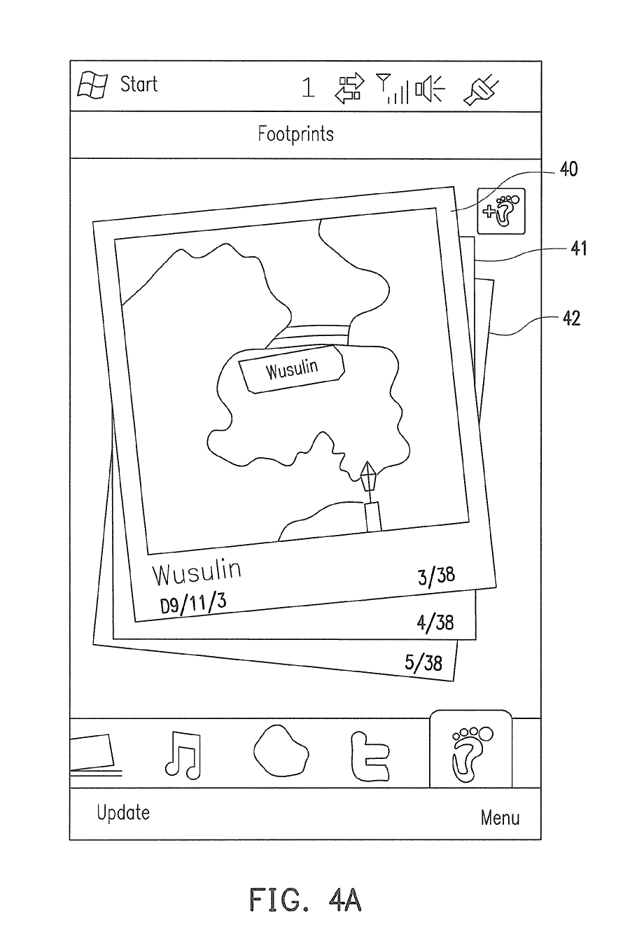

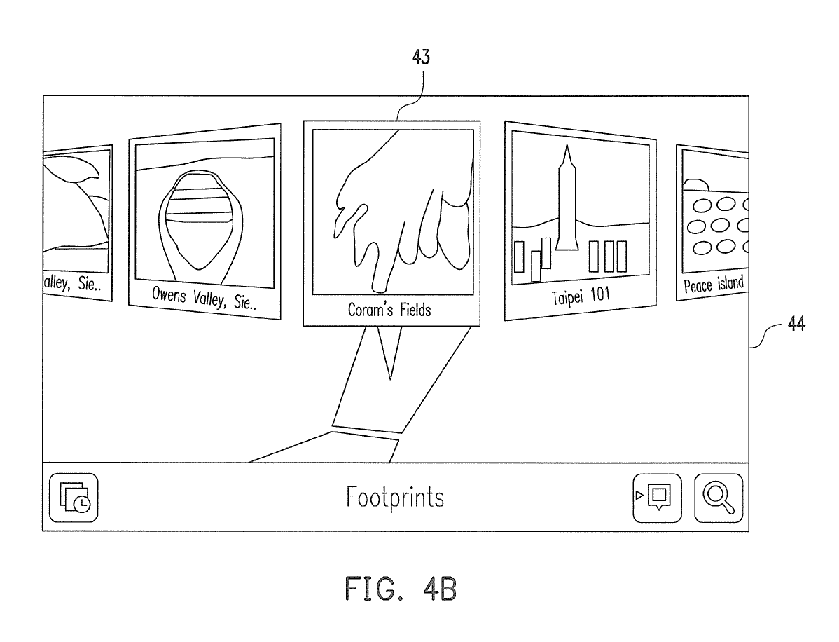

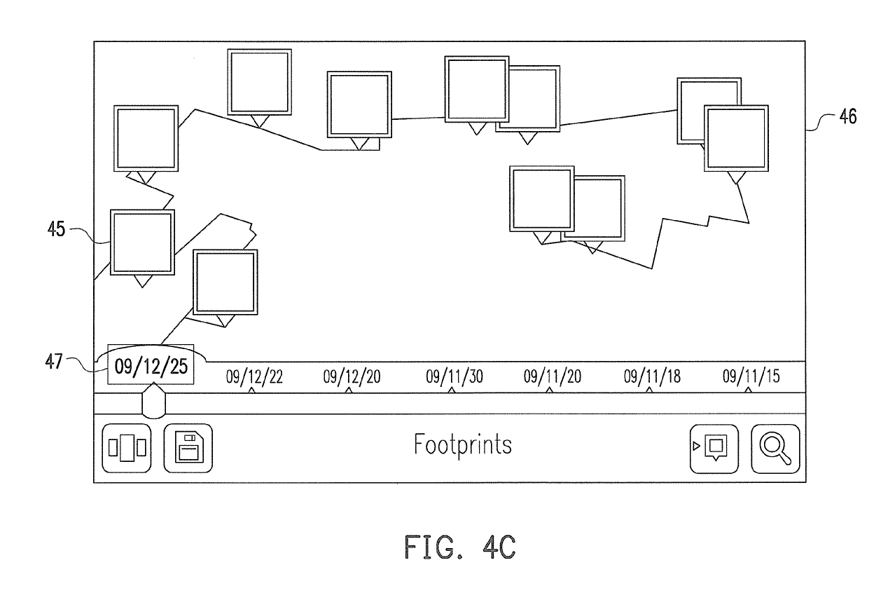

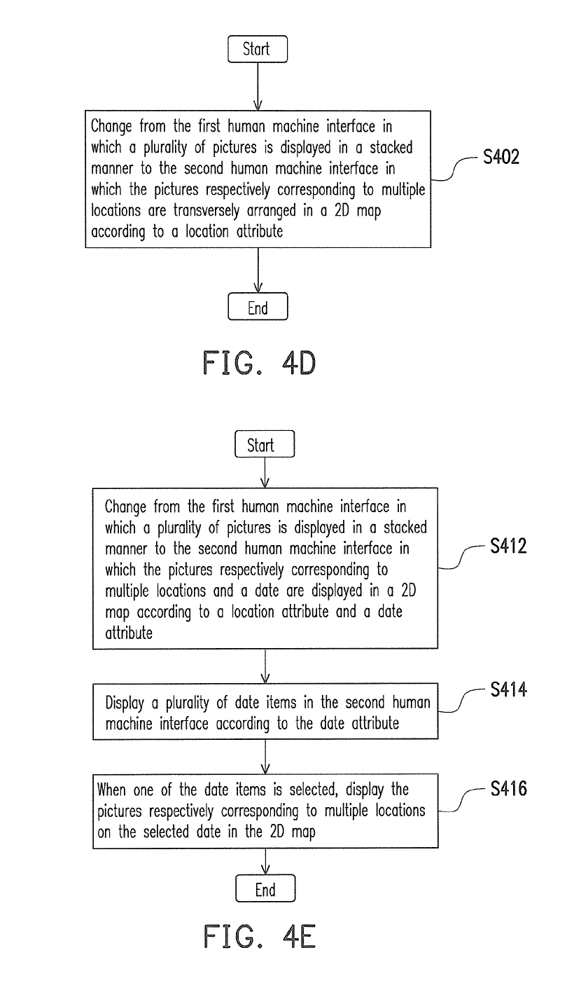

FIG. 4A is a schematic diagram of another first human machine interface. Referring to FIG. 4A, the first human machine interface includes a footprint information image in which a plurality of pictures is displayed in a stacked manner. The footprint information image is a common travel application program, which includes pictures 40, 41, and 42. However, when a user wants to acquire pictures other than the topmost picture 40 displayed in the first human machine interface, the conventional techniques do not provide such method for instantly presenting the information, and the user has to acquire the weather information of other locations through several switching gestures or menu function selections, which can be very inconvenient. Thus, two human machine interface presenting methods for instantly presenting multiple pictures and the corresponding picture capture locations at the same time are provided in the invention, as shown in FIG. 4B and FIG. 4C.

FIG. 4B is a schematic diagram of a second human machine interface according to a third embodiment of the invention. In the present embodiment, when the user changes the orientation of the handheld device 10 from a portrait layout to a landscape layout, the control unit 13 of the handheld device 10 controls the display unit 11 to change from the first human machine interface in which a plurality of pictures is displayed in a stacked manner to the second human machine interface in which the pictures (all similar to the picture 43) respectively corresponding to multiple locations are transversely arranged (or arranged along a horizontal axis) in a 2D map 44 according to a location attribute. In addition, each picture is corresponding to a location at which the picture is originally captured in the 2D map 44. In the present embodiment, the user can switch to different locations through gestures to obtain pictures at these locations.

FIG. 4D is a flowchart of a method for presenting a human machine interface according to the third embodiment of the invention. The procedure illustrated in FIG. 4D is corresponding to the diagram illustrated in FIG. 4B, and FIG. 4D illustrates the detailed technical features of the step S204 more clearly. Referring to FIG. 1 and FIGS. 4A-4D, in step S402, the control unit 13 controls the display unit 11 to change from the first human machine interface in which a plurality of pictures is displayed in a stacked manner (as the image in FIG. 4A) to the second human machine interface in which the pictures respectively corresponding to multiple locations are transversely arranged in a 2D map (as the image in FIG. 4B) according to a location attribute.

FIG. 4C is a schematic diagram of a second human machine interface according to a fourth embodiment of the invention. The present embodiment provides a second human machine interface different from that illustrated in FIG. 4B. In the present embodiment, when a user changes the orientation of the handheld device 10 from a portrait layout to a landscape layout, the control unit 13 controls the display unit 11 to change from displaying the first human machine interface presented by handheld device 10 in the portrait layout to displaying another second human machine interface according to one or more attributes.

The second human machine interface is as shown in FIG. 4C. A 2D map 46 is displayed in the second human machine interface, and the 2D map 46 displays a plurality of locations and corresponding picture objects at the same time (for example, the picture 45 in FIG. 4C). In addition, there a plurality of date items (for example, the date item 47 in FIG. 4C) shown in are a row below the 2D map 46. The user can select a desired date item and switch the 2D map 46 to the selected date to display pictures taken on the selected data and obtain location information corresponding to these pictures.

FIG. 4E is a flowchart of a method for presenting a human machine interface according to a fourth embodiment of the invention. The procedure illustrated in FIG. 4E is corresponding to the diagram illustrated in FIG. 4C, and FIG. 4E illustrates the detailed technical features of the step S204 more clearly. Referring to FIG. 1, FIG. 4A, FIG. 4C, and FIG. 4E, in step S412, the control unit 13 controls the display unit 11 to change from the first human machine interface in which a plurality of pictures is displayed in a stacked manner (as the image in FIG. 4A) to the second human machine interface in which the pictures respectively corresponding to multiple locations and a date are displayed in the 2D map 46 (as the image in FIG. 4C) according to a location attribute and a date attribute. In step S414, the control unit 13 controls the display unit 11 to display a plurality of date items in the second human machine interface according to the date attribute. In step S416, when one of the date items is selected, the control unit 13 controls the display unit 11 to display one or more pictures respectively corresponding to multiple locations on the selected date in the 2D map 46.

Referring to FIG. 4A and FIG. 4C from another perspective, the user can see a plurality of stacked pictures captured at the same location and different time in the first human machine interface illustrated in FIG. 4A and see locations and corresponding pictures taken at different time in the second human machine interface illustrated in FIG. 4C. However, the user can select a different date in the second human machine interface illustrated in FIG. 4C to obtain pictures taken on this date and the corresponding location information. Namely, in FIG. 4C, picture objects corresponding to different locations are presented at the same time according to a location attribute and a time attribute. Through the human machine interface presenting method provided in the invention, the operation of the human machine interfaces is made very convenient and the operation experience of a user is improved.

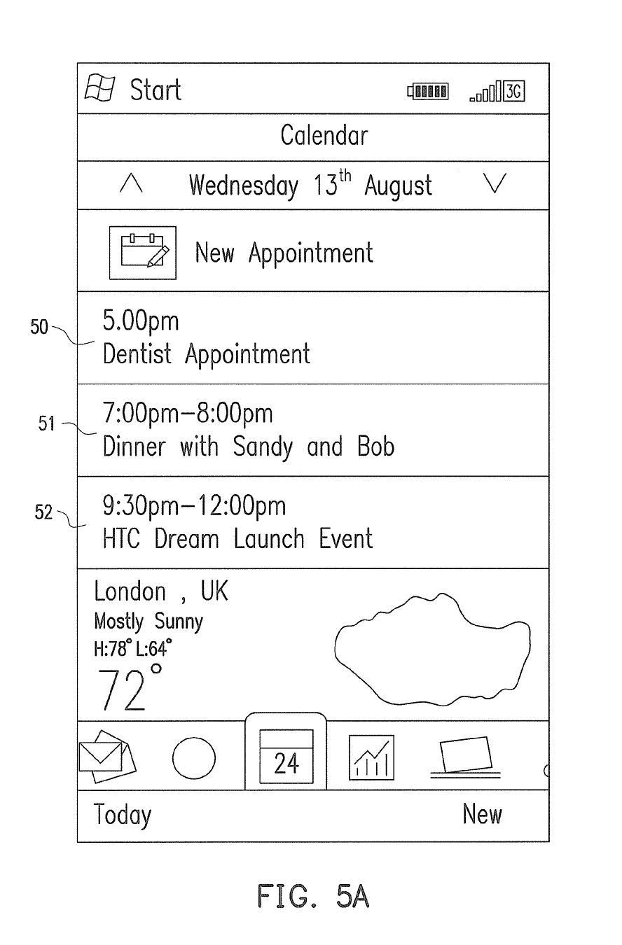

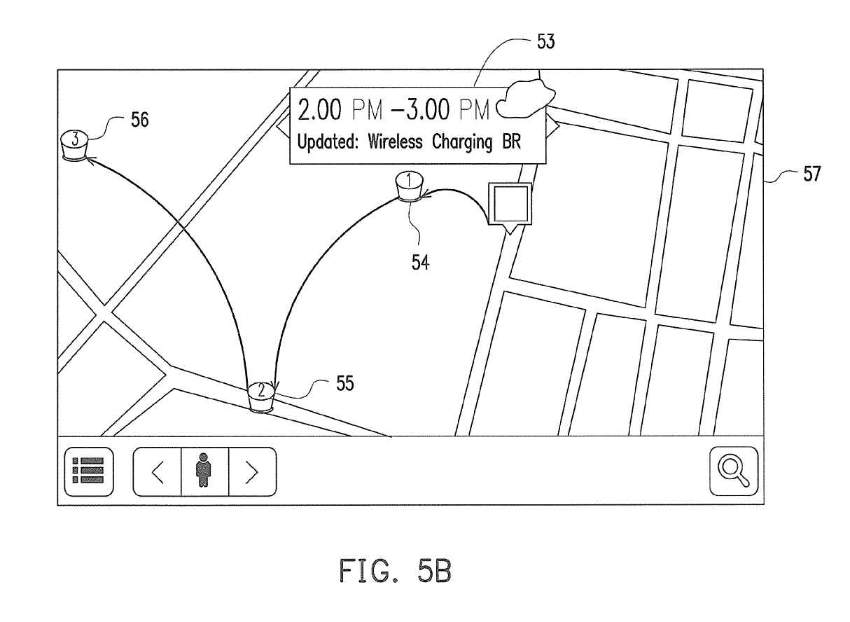

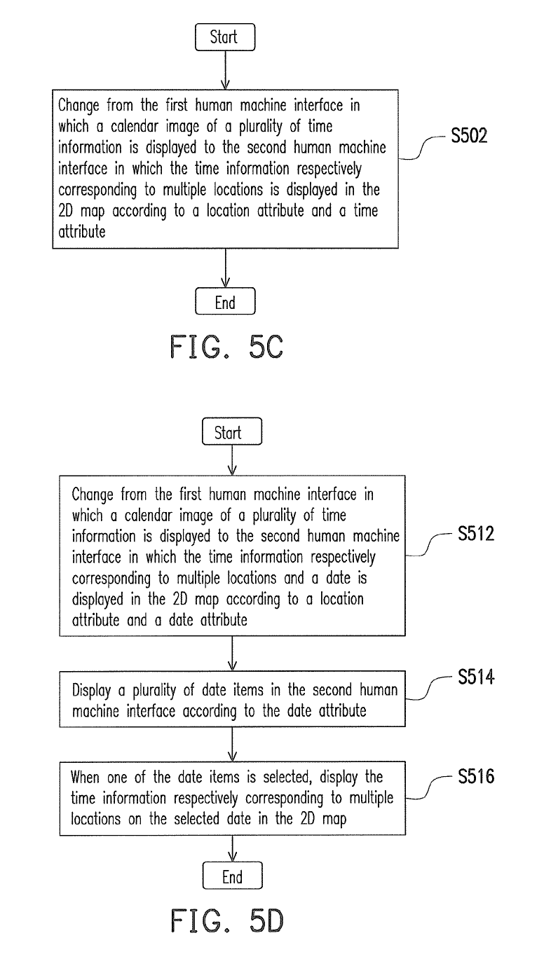

FIG. 5A is a schematic diagram of another first human machine interface. The first human machine interface illustrated in FIG. 5A includes a calendar information image in which a plurality of time information items (for example, time information items 50, 51, and 52) is displayed on a list. The time information item can be a conference, an appointment, or a specific event. When the handheld device is in the landscape layout, the first human machine interface presented by the handheld device does not display the locations respectively corresponding to the time information items.

However, when the user wants to obtain the locations corresponding to these time information items 50, 51, and 52, the user still has to go through several switching gestures or menu function selections, which can be very inconvenient. Thus, in the invention, two human machine interface presenting methods for instantly presenting location information corresponding to time information items are provided, as shown in FIG. 5B.

FIG. 5B is a schematic diagram of a second human machine interface according to a fifth embodiment of the invention. In the present embodiment, when a user changes the orientation of the handheld device 10 from a portrait layout to a landscape layout, the control unit 13 of the handheld device 10 generates a second attribute set according to the change, and the control unit 13 controls the display unit 11 to display a second content different from the first content according to the second attribute set. Namely, the first human machine interface presented when the handheld device 10 is in the portrait layout is switched to another second human machine interface. In the fifth embodiment, the first attribute set just contains time information and corresponding time information items, but the second attribute set contains time information, location information, and corresponding time information items.

The second human machine interface is as shown in FIG. 5B. Referring to FIG. 5B, a 2D map 57 is displayed in the second human machine interface, and the 2D map 57 displays location items 54, 55, and 56 respectively corresponding to the time information items 50, 51, and 52 in FIG. 5A. The 2D map 57 also displays a previous time information item 53. Thus, the user can conveniently obtain location items corresponding to all time information items in the second human machine interface.

FIG. 5C is a flowchart of a method for presenting a human machine interface according to the fifth embodiment of the invention. The procedure illustrated in FIG. 5C is corresponding to the diagram illustrated in FIG. 5B, and FIG. 5C illustrates the detailed technical features of the step S204 more clearly. Referring to FIG. 1 and FIGS. 5A-5C, in step S502, the control unit 13 controls the display unit 11 to change from the first human machine interface in which a calendar image of a plurality of time information is displayed (as the image in FIG. 5A) to the second human machine interface in which the time information respectively corresponding to multiple locations is displayed in the 2D map 57 (as the image in FIG. 5B) according to a location attribute and a time attribute.

In another embodiment of the invention, the user can also directly select any location item in the 2D map 57 in the second human machine interface illustrated in FIG. 5B to search for, for example, restaurants, bus stations, subway stations (or metro stations), or convenience stores, around the location item 54. Alternatively, the user can further directly select a new location item in the 2D map 57 and insert a new time information item into the selected location item, so as to re-schedule the calendar.

FIG. 5D is a flowchart of a human machine interface presenting method according to a sixth embodiment of the invention. The human machine interface presenting method in FIG. 5D integrates the technique illustrated in FIG. 5B and the technique illustrated in FIG. 4C for displaying a plurality of time information items. Referring to FIG. 1, FIG. 4C, FIG. 5A, and FIG. 5D, in step S512, the control unit 13 controls the display unit 11 to change from the first human machine interface in which a calendar image of a plurality of time information is displayed to the second human machine interface in which a plurality of time information (for example, the time information items 50, 51, and 52) respectively corresponding to multiple locations (for example, the location items 54, 55, and 56) and a date is displayed in the 2D map 57 according to a location attribute and a date attribute.

In step S514, the control unit 13 controls the display unit 11 to display a plurality of date items in the 2D map 57 in the second human machine interface according to the date attribute. In step S516, when one of the date items is selected, the control unit 13 controls the display unit 11 to display a plurality of time information respectively corresponding to multiple locations on the selected date in the 2D map 57.

The invention further provides a computer-readable medium, and the computer-readable medium stores a computer executable program, which is configured for executing various steps of the aforementioned method for presenting the human machine interface. The computer-readable medium is composed of a plurality of program instructions (for example, an organization chart establishing program instruction, a table approving program instruction, a setting program instruction, and a deployment program instruction, etc), and these program instructions are loaded into the handheld device and executed by the same to accomplish various steps of the human machine interface presenting method and the functions of the handheld device described above.

In summary, embodiments of the invention provide a human machine interface presenting method, a handheld device using the same, and a computer readable medium thereof. When the handheld device is detected to change from a portrait layout to a landscape layout, an originally displayed first human machine interface is switched to a second human machine interface, so as to present a plurality of information items with different attributes to a user. Thereby, the number of switching operations or selection operations of a user to obtain aforementioned information items is reduced in the second human machine interface. In addition, the operation of the human machine interfaces is made very convenient, and the operation experience of the user is improved.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A human machine interface presenting method, adapted to a handheld device, the human machine interface presenting method comprising:
(a) displaying a first content generated according to a first attribute set;
(b) detecting a change in an orientation of the handheld device;
(c) generating a second attribute set according to the change; and
(d) displaying a second content different from the first content according to the second attribute set, wherein the first attribute set and the second attribute set comprise at least an identical attribute.

2. The human machine interface presenting method according to claim 1, wherein the first content is a first human machine interface, the second content is a second human machine interface, the change is that the handheld device changes from a portrait layout to a landscape layout, and the step (d) is a step of changing from displaying the first human machine interface to displaying the second human machine interface according to the second attribute set.

3. The human machine interface presenting method according to claim 2, wherein the step (d) comprises:
changing from the first human machine interface in which a weather information image of a single location is displayed to the second human machine interface in which a simplified weather information image of a plurality of locations is displayed in a 3D earth image according to a location attribute.

4. The human machine interface presenting method according to claim 2, wherein the step (d) comprises:
changing from the first human machine interface in which a weather information image of a single location is displayed to the second human machine interface in which a simplified weather information image of a plurality of locations is displayed in a 2D world map image according to a location attribute.

5. The human machine interface presenting method according to claim 2, wherein the step (d) comprises:
changing from the first human machine interface in which a plurality of pictures is displayed in a stacked manner to the second human machine interface in which the pictures respectively corresponding to a plurality of locations are transversely arranged in a 2D map according to a location attribute.

6. The human machine interface presenting method according to claim 2, wherein the step (d) comprises:
changing from the first human machine interface in which a plurality of pictures is displayed in a stacked manner to the second human machine interface in which the pictures respectively corresponding to a plurality of locations and a date are displayed in a 2D map according to a location attribute and a date attribute;
displaying a plurality of date items in the second human machine interface according to the date attribute; and
when one of the date items is selected, displaying the pictures respectively corresponding to a plurality of locations on the selected date in the 2D map.

7. The human machine interface presenting method according to claim 2, wherein the step (d) comprises:
changing from the first human machine interface in which a calendar image of a plurality of time information is displayed to the second human machine interface in which the time information respectively corresponding to a plurality of locations is displayed in a 2D map according to a location attribute and a time attribute.

8. The human machine interface presenting method according to claim 7, wherein:
when the handheld device is in the landscape layout, the first human machine interface does not display the locations respectively corresponding to the time information.

9. The human machine interface presenting method according to claim 8, wherein the step (d) further comprises:
changing from the first human machine interface in which a calendar image of a plurality of time information is displayed to the second human machine interface in which the time information respectively corresponding to a plurality of locations and a date is displayed in a 2D map according to a location attribute and a date attribute;
displaying a plurality of date items in the second human machine interface according to the date attribute; and
when one of the date items is selected, displaying the time information respectively corresponding to a plurality of locations on the selected date in the 2D map.

10. A handheld device, comprising:
a display unit, configured for displaying a first content, wherein the first content is generated according to a first attribute set;
a detecting unit, configured for detecting a change in an orientation of the handheld device; and
a control unit, connected to the display unit and the detecting unit, configured for generating a second attribute set according to the change and controlling the display unit to display a second content different from the first content according to the second attribute set, wherein the first attribute set and the second attribute set comprise at least an identical attribute.

11. The handheld device according to claim 10, wherein the first content is a first human machine interface, the second content is a second human machine interface, the change is that the handheld device changes from a portrait layout to a landscape layout, and the control unit controls the display unit to change from displaying the first human machine interface to displaying the second human machine interface according to the second attribute set.

12. The handheld device according to claim 10, wherein:
when the handheld device changes from the landscape layout to the portrait layout, the control unit controls the display unit to change from displaying the second human machine interface to displaying the first human machine interface.

13. The handheld device according to claim 12, wherein:
when the detecting unit detects that the handheld device changes from the portrait layout to the landscape layout, the control unit controls the display unit to change from the first human machine interface in which a weather information image of a single location is displayed to the second human machine interface in which a simplified weather information image of a plurality of locations is displayed in a 3D earth image according to a location attribute.

14. The handheld device according to claim 12, wherein:
when the detecting unit detects that the handheld device changes from the portrait layout to the landscape layout, the control unit controls the display unit to change from the first human machine interface in which a weather information image of a single location is displayed to the second human machine interface in which a simplified weather information image of a plurality of locations is displayed in a 2D world map image according to a location attribute.

15. The handheld device according to claim 12, wherein:
when the detecting unit detects that the handheld device changes from the portrait layout to the landscape layout, the control unit controls the display unit to change from the first human machine interface in which a plurality of pictures is displayed in a stacked manner to the second human machine interface in which the pictures respectively corresponding to a plurality of locations are transversely arranged in a 2D map according to a location attribute.

16. The handheld device according to claim 12, wherein:
when the detecting unit detects that the handheld device changes from the portrait layout to the landscape layout, the control unit controls the display unit to change from the first human machine interface in which a plurality of pictures is displayed in a stacked manner to the second human machine interface in which the pictures respectively corresponding to a plurality of locations and a date are displayed in a 2D map according to a location attribute and a date attribute;
the control unit displays a plurality of date items in the second human machine interface according to the date attribute; and
when one of the date items is selected, the control unit controls the display unit to display the pictures respectively corresponding to a plurality of locations on the selected date in the 2D map.

17. The handheld device according to claim 12, wherein:
when the detecting unit detects that the handheld device changes from the portrait layout to the landscape layout, the control unit controls the display unit to change from the first human machine interface in which a calendar image of a plurality of time information is displayed to the second human machine interface in which the time information respectively corresponding to a plurality of locations is displayed in a 2D map according to a location attribute and a time attribute.

18. The handheld device according to claim 17, wherein:
when the detecting unit detects that the handheld device is in the portrait layout, the control unit controls the display unit to display the first human machine interface in the display unit and controls the first human machine interface not to display the locations respectively corresponding to the time information.

19. The handheld device according to claim 12 further comprising:
when the detecting unit detects that the handheld device changes from the portrait layout to the landscape layout, the control unit controls the display unit to change from the first human machine interface in which a calendar image of a plurality of time information is displayed to the second human machine interface in which the time information respectively corresponding to a plurality of locations and a date is displayed in a 2D map according to a location attribute and a date attribute;
the control unit controls the display unit to display a plurality of date items in the second human machine interface according to the date attribute; and
when one of the date items is selected, the control unit controls the display unit to display the time information respectively corresponding to a plurality of locations on the selected date in the 2D map.

20. A computer-readable medium storing a computer executable program, wherein when the computer executable program is loaded to a handheld device, the handheld device executes the following steps:
displaying a first content generated according to a first attribute set;
detecting a change in an orientation of the handheld device;
generating a second attribute set according to the change; and
displaying a second content different from the first content according to the second attribute set, wherein the first attribute set and the second attribute set comprise at least one same attribute.
